(19) United States
(12) Patent Application Publication
(10) Pub. No.: US 2016/0161183 A1
(43) Pub. Date: Jun. 9, 2016

(54) Dryer for Articles of Clothing

(71) Applicants: Russell A. Barnes, Corinth, TX (US); Michael L. Camp, Denton, TX (US); Thomas C. Pullen, Ponder, TX (US)

(72) Inventors: Russell A. Barnes, Corinth, TX (US); Michael L. Camp, Denton, TX (US); Thomas C. Pullen, Ponder, TX (US)

(21) Appl. No.: 14/562,843

(22) Filed: Dec. 8, 2014

(51) Int. Cl. F26B 21/00

(52) U.S. Cl. CPC F26B 21/006

(57) ABSTRACT

A dryer for articles of clothing such as athletic gloves, socks and shoes includes a housing having handle portion and an air discharge guide member. A fan, fan motor and battery pack are located within the housing. Means are provided on the outer surface of the air discharge guide member to secure the article of clothing to the air discharge guide member as air is directed through the article of clothing.

### BACKGROUND OF INVENTION

1. Field of the Invention

The invention disclosed herein is directed to a portable dryer for articles of clothing such as a golf glove, a batting glove, shoes, socks and the like. The dryer generates a flow of air through a confined outlet. A mechanism for supporting the glove so that air is directed into the interior of the glove is also provided.

2. Description of Related Art

U.S. Pat. No. 5,983,518 discloses a glove dryer including a fan operated by batteries and a support mechanism for securing the glove to the device such that the flow of air is directed into the interior of the glove. A clip is used to support the dryer on a tubular member of a golf cart.

U.S. Pat. No. 5,570,515 discloses a device for drying articles of clothing that includes a battery operated fan and two discharge outlet tubes. The device is either hand held or supported by the article to be dried. Both devices fail to show an arrangement for positively securing the glove to the discharge outlet so as to ensure that the glove will not be separated from the device in use.

### BRIEF SUMMARY OF THE INVENTION

This invention disclosed herein is for a portable dryer that includes a discharge outlet and a mechanism to positively secure the article being dried at the discharge outlet. The mechanism is adapted to accommodate articles having different size wrist portions.

An embodiment of the invention includes a plurality of annular ribs formed on the outside of the air discharge guide member that are axially spaced. The air discharge guide member is a tapering frustoconical member which cooperates with the ribs to support articles such as gloves having a varying wrist width.

### BRIEF DESCRIPTION OF THE SEVERAL VIEWS OF THE DRAWING(S)

FIG. 1 is a perspective view of an embodiment of the invention.

FIG. 2 is a cross-sectional view of an embodiment of the invention.

FIG. 3 is a cross-sectional view taken along line 3-3 of FIG. 2.

### DETAILED DESCRIPTION OF THE INVENTION

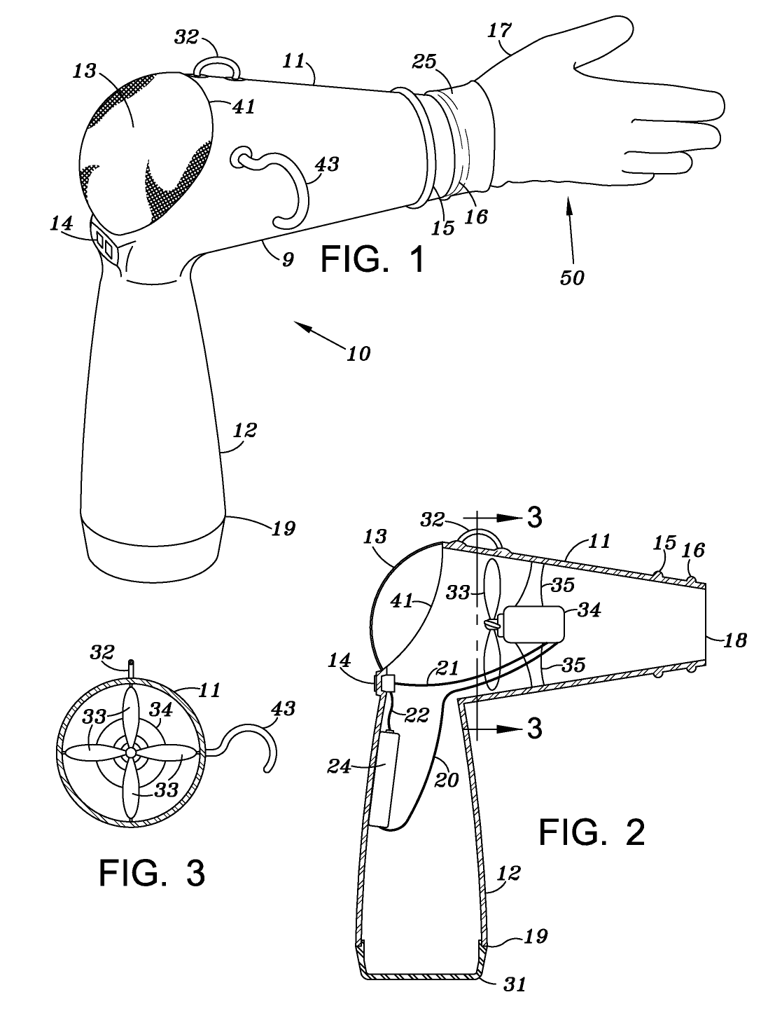

Referring to FIG. 1, an embodiment of the dryer 10 includes a housing 9 having a hollow handle portion 12 with a lower section 19 which is generally cylindrical in shape, and an air discharge guide 11 that extends laterally of hand portion 12. A cut out section 41 is provided at the junctive of handle portion 12 and air discharge guide 11 to provide an inlet for air. Cutout portion 41 may be covered by a screen 13 for safety purposes and to prevent solid material from entering.

Referring to FIG. 2, a battery pack including wires 20 and 22 is conveniently located at any suitable location within handle portion 12. A switch 14 is positioned to activate exteriorly of the device in FIG. 1. Wire 22 from the battery pack is connected to switch 22 and wire 20 extends from battery pack 24 to a fan motor 34. A third wire 21 extends from switch 14 to fan motor 34. Fan motor 34 is mounted within air discharge guide 11 by a plurality of struts 35. A fan having a plurality of fan blades 33 for example four is connected to the fan motor as is known in the art.

Air discharge guide is in the shape of frustroconical member tapering from air inlet 41 to air outlet 18. A plurality of radially spaced annular ribs 15 and 16 are formed on the outside periphery of air discharge guide 11 adjacent air outlet 18. As shown in FIG. 1, the wrist portion 25 of glove 50 can be slid over first rib 16 and held in place by virtue of the fact that most athletic gloves have either a resilient wrist portion or an adjustable size due to the provision of an adjustable strap.

Thus a child's size glove may be held in place by rib 16 whereas it would be necessary to place a larger size glove for example an adult size glove over rib 15 to secure it in place.

An access door for battery pack 24 may be placed adjacent the battery pack for replacing the batteries.

Lower portion 19 and bottom 31 allows for the dryer to be placed within a beverage cup holder for support. Such beverage cup holders are typically located within golf carts for example.

An eyelet 32 may be provided on the housing for attachment to a strap or the like. Additionally a hook 43 may extend outwardly of discharge guide 11 for attaching the dryer to a fence or the like.

Although the present invention has been described with respect to specific details, it is not intended that such details should be regarded as limitations on the scope of the invention, except to the extent that they are included in the accompanying claims.

1. A dryer for articles of clothing comprising,
a housing including a handle portion,
an air discharge guide member having an air inlet and outlet,
a fan and fan motor located within the housing,
a switch connected between the battery and the fan motor positioned on the housing; and
means for securing an article of clothing to the air discharge guide member.

2. A dryer as claimed in claim 1 further including a screen positioned over the air inlet of the air discharge guide member.

3. A dryer as claimed in claim 1 wherein the means for securing an article of clothing to the air discharge guide member comprises at least one annular rib on an outer surface of the air discharge guide member.

4. A dryer as claimed in claim 3 including a plurality of axially spaced annular ribs on an outer surface of the air discharge guide member.

5. A dryer as claimed in claim 1 including a battery for supplying power to the fan motor.

6. A dryer as claimed in claim 1 wherein the fan and fan motor are positioned within the air discharge guide member.
